(19) United States
(12) Patent Application Publication
(10) Pub. No.: US 2004/0028779 A1
(43) Pub. Date: Feb. 12, 2004

(54) System and method for adding olfactory detected properties to an ingested product through scented packaging

(76) Inventor: Steven M. Landau, Meadowbrook, PA (US)

Correspondence Address: Eric A. LaMorte, LaMorte & Associates, P.C., P.O. Box 434, Yardley, PA, 19067, US

(21) Appl. No.: 10/638,191

(22) Filed: Aug. 11, 2003

Related U.S. Application Data
(63) Continuation-in-part of application No. 10/211,537, filed on Aug. 5, 2002.
Application No. 10/211,537 is a continuation-in-part of application No. 08/797,593, filed on Feb. 7, 1997, now abandoned.

(51) Int. Cl. A23G 1/00

(52) U.S. Cl. 426/132

(57) ABSTRACT

A system and method of adding olfactory detected properties to an ingestible product. An ingestible product is placed within packaging made from a plastic that is supersaturated with a fragrance material. The fragrance material blooms from the surfaces of the packaging and scents both the interior and exterior surfaces of the packaging. Scent on the interior adds olfactory detectable properties to the ingestible product that are not native to that product. The scent on the exterior of the packaging helps olfactory sense deception to occur when the ingestible product is consumed from the packaging. As such, a person consuming the ingestible product will perceive flavors never directly added to the ingestible product.

### RELATED APPLICATIONS

This application is a continuation-in-part of U.S. patent application Ser. No. 10/211,537, entitled Receptacle Having Aromatic Properties, filed on Aug. 8, 2002, which is a continuation-in-part of U.S. patent application Ser. No. 08/797,593, entitled BOTTLE CAP CLOSURE WITH FLAVORING COMPONENT, filed on Feb. 7, 1997.

### BACKGROUND OF THE INVENTION

1. Field of the Invention

In general, the present invention relates to systems and methods of adding scent and/or flavoring to an ingested product. More particularly, the present invention relates to systems and methods that add scent and/or flavoring to an ingested product by placing that material into a unique packaging environment.

2. Prior Art Statement

The adding of flavoring to ingested products through exposure to a secondary product has been in existence for thousands of years. One phenomenon that transfers flavoring to one product to another is leaching. Leaching is the process when oils or other compounds from a first material migrate into a second material that contacts the first material. Many wines are aged in barrels of different woods, wherein flavoring from the wood leaches into the wine and imparts a subtle flavor to the wine. Many fine liquors, such as scotch, brandy, whisky and the like also receive flavoring from the barrels in which they are stored and aged.

However, not all flavoring due to leaching is good. In modern manufacturing many food and drink containers and closures are made of molded plastic. Such containers include soda bottles, water bottles, milk bottles, yogurt cups, microwave trays, juice containers, chewing tobacco containers and the like. When plastic is first molded, it goes through a period of degassing, where the molded plastic emits a strong scent. It is the degassing of plastic that provides a newly manufactured car with its “new car” smell. The period of degassing can last from several minutes to several years, depending upon the type of plastic being molded and the mass of the plastic present. Furthermore, as plastic ages and is exposed to light, air, moisture and environmental pollutants, the plastic degrades. As plastic degrades, the plastic emits, oils, gas and other compounds.

Undesired emissions from plastic containers are also generated during the retort procedure of many packaged foods. Many packaged foods and beverages that are packaged in plastic containers also undergo retort processing. Retort processing is when a container filled with a food or beverage heated to a temperature of between 140 degrees to 200 degrees for a period of time to kill any harmful bacteria that may have found its way into the product packaging. When plastic containers are heated to such temperatures, they emit various gases and oils that degrade the flavor of the food or beverage being packaged. The retort process also degrades aroma and flavors in products as the heating temperatures also burn off desirable flavor notes.

When an ingestible product is stored in a plastic container, the emissions from the plastic caused by degassing and degradation are dissolved and/or mixed with the contents of the container. The emissions from the plastic have an adverse affect on the flavor of the container's contents, often causing liquids and solid consumables to taste “like plastic” or “stale”. If the contents of a container are flavored and the contents do not undergo a retort process, such as with soda in a soda bottle, then emissions from the plastic are usually not noticeable by a person consuming the stored product, provided the product is relatively fresh. However, if the stored product is not flavored, is not refrigerated and/or is subject to a retort process, then the adverse effects of the plastic leaching becomes more noticeable. For example, if a plastic bottle or closure is used to hold water and is carried by a hiker on a hot day, there is a good chance that the flavor of the water will be adversely affected by plastic leaching when the water is drunk.

Another problem that exists in the prior art, is the problem of flavor degradation during processing. Often flavoring is added to food or beverages prior to that material being processed. As the ingestible material is processed, some of the stronger flavor aspects, called “top notes”, are degraded. As such, the beverage or consumable does not taste as good after heat processing as it would have prior to heat processing. Fresh squeezed orange juice vs. orange juice from a carton is a good example of this.

A third problem that exists in the beverage and consumable industry is how to maintain freshness. As beverages and consumables age, there is typically an adverse effect on flavor. In the industry, the expiration date that is placed on a beverage or consumable is many times determined by the onset of flavor staleness.

The problems of staleness and plastic flavoring can be addressed using artificial flavoring and preservatives. However, in many products, such additives either cannot be added or are expected by the consuming public not to be present.

In an attempt to flavor consumables without adding flavoring additives, devices have been developed that depend upon the physiological phenomenon of olfactory sense deception. A person's sense of taste is mostly regulated by that person's sense of smell. It is a well known physiological phenomenon that the tongue only tastes four basic sensations, sweet, sour, bitter and salty, plus umami (sometimes described as mouth-feel) all other taste is a result of the sense of smell. When people eat and drink, food and liquids form vapors inside the mouth which travel through the back of the throat up the retro-nasal canal until they reach the olfactory bulb where the aromatic vapor is translated as taste by the brain. Therefore a person who smells a strong aroma while eating or drinking will believe that the food or drink being consumed is flavored in a manner corresponding to that smell. In a process not fully understood by science, the human brain receives sensory input from both the nose and the mouth. If the sensory inputs do not correspond, the signals are mixed by the brain. As a result, the brain is tricked into believing that the taste of the food or drink being consumed is the source of the smell. The brain therefore assigns a false flavor to the food or drink being consumed that corresponds to that smell. For the purpose of this disclosure, such a physiological phenomenon is referred to as olfactory sense deception.

U.S. Pat. No. 5,635,229 to Ray, entitled Beverage Container Including An Affixed Scent Disbursement Means For Enhancing Perceived Flavor Of The Beverage, shows a prior art device that relies upon olfactory sense deception. In the referenced Ray patent, an aromatic ring is placed around the neck of a bottle. As a person drinks from the bottle, they smell the aromatic ring, wherein olfactory sense deception is hopefully induced.

The olfactory sense receptors in the sinuses receive scents in two different ways. The first way is when a person inhales through his/her nose. The second way is when air enters the sinus cavity from the back of the mouth. A problem associated with prior art devices, such as that described in the Ray patent, is that the aromatic source is located only outside the nose. Therefore, the scent of the aromatic source is only perceived when a person inhales through his/her nose. Furthermore, the aromatic source of the Ray patent is only located outside of the nose, while a person is in the process of drinking.

Humans are born with the ability to breathe and drink simultaneously. However, this ability is lost shortly after infancy as the anatomy of the body changes. As such, most all people over the age of two cannot drink and breathe simultaneously. As such, it is not possible for a person to breathe through his/her nose at the exact moment that he/she is drinking. As a result, prior art devices that position a scented object outside the nose only while a person is drinking are fundamentally flawed. Additionally, as a person in drinking or eating, the scent of the material being consumed travels into the sinus from within the mouth. Consequently, the true smell of the material being consumed is smelled and the degree of olfactory sense deception is decreased.

In order to produce olfactory sense deception, a scent must be presented at the time of consumption that is not original to the product being ingested. The most practical way to produce such scent is to scent at least part of the packaging that holds the product to be eaten. Most often, that packaging for ingested products contains plastic.

In the prior art, scents have been added to plastics. Scented plastic is commonly used in animal chew toys and infant toys. Scents such a vanilla and watermelon are commonly used. Naarden International USA Inc. of New York, N.Y. once produced a plastic additive they deemed polymer flavor/fragrance concentrates (PFC's) for adding fragrance to polyethylene, polypropylene, ethylene vinyl acetate, polystyrene, nylon, polyester and polyvinyl chloride. However, the mere adding of scent to plastic is far different from creating a plastic that will pass scent into a packaged ingestible product. The Federal Food and Drug Administration, FDA has regulations that govern what materials are allowed to effect food “through migration from their immediate wrapper, container or other food contact surface.” See Code of Federal Regulations, Title 21, Volume 3, Section 186.1(b).

Under the FDA guidelines, only materials that have been determined to be “generally recognized as safe” (GRAS) as a food additive can be used to indirectly effect the flavor of an ingested product. In the plastics molding industry, historically most fragrances used to scent plastic are perfume oils or scented oils that are not food additives and thus have not been generally recognized as safe as food additives. Such scenting materials therefore cannot be legally used to migrate fragrance into food or beverages.

As a consequence, only GRAS food additives can be mixed with plastics to scent or flavor plastics, if the plastic is going to contact the ingested product and affect its flavor. The problem is that plastic is molded at temperatures usually exceeding three hundred degrees. As such temperatures, many GRAS food additives loose potency and become entrapped within the structure of the molten plastic. As such, the plastic produced does not have a strong scent and has little effect on the ingestible product being packaged.

A need therefore exists for a system and method of making plastic packaging that is strongly flavored and scented with GRAS additives so that the GRAS additives both migrate from the plastic and cause olfactory sense deception, thereby having a positive effect upon the perceived flavor of the ingestible material. A need also exists for a method of replacing top note flavoring lost during heat processing. Lastly, a need exists for a method of preventing staleness, in order to prolong the shelf life of many products. These needs are met by the present invention as described and claimed below.

### SUMMARY OF THE INVENTION

The present invention is a system and method of adding olfactory detected properties to an ingestible product through the packaging of that product. An ingestible product is placed into plastic packaging. The plastic packaging is made from plastic that is supersaturated with flavored material that is FDA approved as a food additive. The flavored material blooms from the surfaces of the packaging over time, thereby providing aroma and flavor to both the interior and exterior surfaces of the packaging.

The ingestible product is placed in the packaging. The olfactory detectable properties of the flavored material are absorbed by the ingestible product over time. Furthermore, since the packaging is flavored both internally and externally, the added flavor permeates the air when the packaging is opened and the ingestible product is consumed. This produces olfactory sense deception that causes a product to have a fresher aroma and taste profile, and sets consumer expectation for a better, fresher eating/drinking experience.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is block diagram of a method of adding olfactory detected properties to a processed ingestible product through the packaging of that product;

FIG. 2 is side view of a water bottle container made from fragrance impregnated plastic in accordance with the present invention;

FIG. 3 is a side view of the water bottle container of FIG. 2, shown in conjunction with a person's face to illustrate how the bottle container causes olfactory sense deception;

FIG. 4 is a side view of a cup-shaped container made in accordance with the present invention, shown with a person's face to illustrate how the container creates olfactory sense deception;

FIG. 5 is a cross-sectional view of a plastic tray container holding food, shown with a person's face to illustrate how the container creates olfactory sense deception;

FIG. 6 is a cross-sectional view of bottle container, having a cap sealing system in accordance with the present invention; and

FIG. 7 is a cross-sectional view of a can container having a plastic liner that is manufactured in accordance with the present invention.

### DETAILED DESCRIPTION OF THE INVENTION

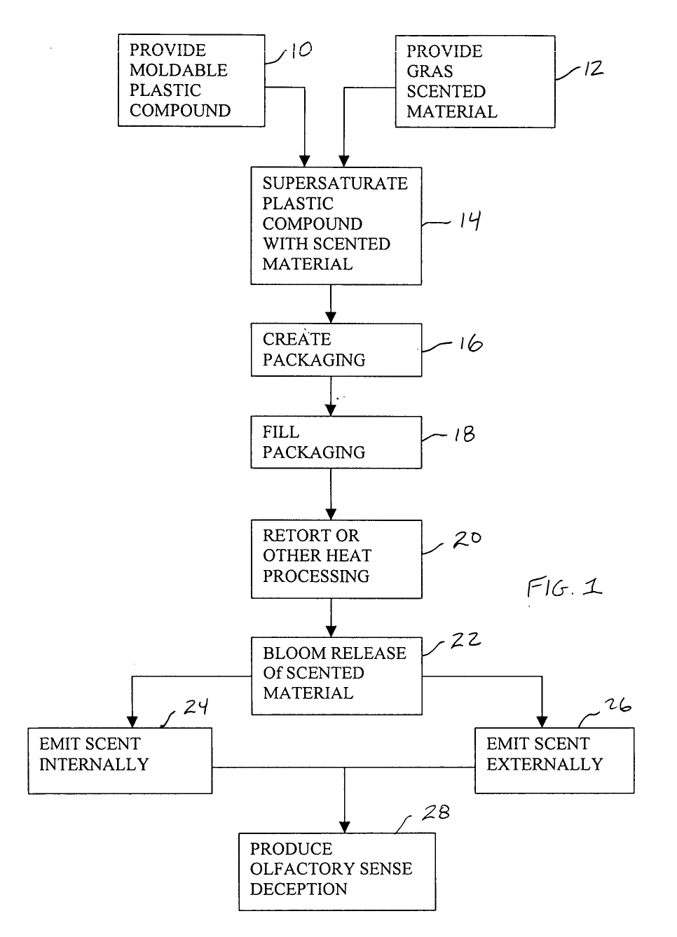

Referring to FIG. 1, a method is described for packaging an ingestible product in accordance with the present invention. The packaging, for the purpose of this disclosure, should be considered any protective cover that protects an ingestible product, that contains plastic in part or in whole. Such packaging can be considered plastic bottles, glass bottles with plastic caps, bottles with plastic cap seals, bags, pouches, laminated containers, cups, trays, bags, bowls, or any other container in which ingestible products are traditionally packaged and sold. As can be seen from Block 10, in FIG. 1, a traditional plastic compound is provided for manufacturing a product packaging, whatever form that packaging may take.

As is indicated by Block 12, a volume of GRAS flavored material is also provided. GRAS flavored materials are FDA approved food additives that are used to naturally or artificially flavor and/or scent ingestible products. Such GRAS flavored material is typically manufactured to have the aroma of a food product. GRAS flavored material can be manufactured in many forms, including powders and oils. In one form of manufacture, the GRAS flavored material can be encapsulated, forming an encapsulated plastic flavor (EPS). And EPS flavored material tend to retain more of their flavor and scent during high heat processing than other forms of GRAS flavored material.

The selected GRAS flavored material is preferably complimentary to the ingestible product that is to be packaged. For example, the ingestible product may be a chocolate flavored energy drink to be packaged in a plastic bottle container. The GRAS scented material mixed into the plastic of the bottle container or closure preferably has a chocolate flavor aroma that compliments the natural scent of the flavored energy drink. Alternatively, the GRAS flavored material can be flavored with a banana aroma. This flavor/aroma is diverse from the natural flavor/aroma of the energy drink, yet compliments the scent from the perception of taste.

As is indicated by Block 14, the GRAS flavored material is mixed with the plastic compound in a concentration so that the GRAS flavored material saturates the plastic compound at the molding temperature of the plastic compound and supersaturates the plastic compound at ambient temperature. In this manner, the GRAS flavored material will fully mix with the plastic compound prior to the plastic compound being molded into packaging. However, as soon as the plastic compound is molded into the packaging and the packaging begins to cool, the GRAS scented material will begin to precipitate out of solution. Since the plastic compound is a solid, the supersaturation of the GRAS flavored material will cause the GRAS flavored material to very gradually bloom to the exposed surfaces of the packaging.

Bloom is a term of art in plastics that refers to the migration of a liquid or solid material from the composition of the plastic to the surface of the plastic. Bloom is caused when a dissolved ingredient is added to the plastic compound recipe in a concentration that is in excess of its solubility. In such a situation, if the conditions for crystallization of the supersaturated ingredient are more favorable in the presence of air than within the body of the plastic compound, then the supersaturated ingredient will separate out of the plastic compound and crystallize at the surface of the plastic as it contacts the surrounding air. The change in the saturation concentration gradient created by the surface crystallization causes the supersaturated ingredient to migrate from within the plastic compound toward the exterior surfaces of the plastic compound. The bloom of the supersaturated ingredient will continue over time until the concentration of the blooming ingredient within the plastic compound falls to a concentration corresponding to the saturation point of the plastic compound. Bloom ceases when the concentration of the migrating substance in the plastic compound becomes equal to its solubility at a given temperature.

From Block 16, it can be seen that the plastic compound, saturated with the GRAS flavored material is molded or otherwise formed into the structure of the product packaging. As the packaging cools, the GRAS flavored material supersaturates the plastic compound and bloom slowly begins.

As is indicated by Block 18, once the packaging is complete, the packaging is filled with an ingestible product. Once the ingestible product is placed into the packaging, the ingestible product is in intimate contact with the packaging. Accordingly, as scent vapors migrate and bloom from the plastic packaging, the migrating scent is directly exposed to the ingestible material.

Once the packaging is filled with the ingestible material, the packaging is sealed and may undergo a retort process. In the retort process, the packaging is heated. During this process, energy is provided to the GRAS flavored material that has bloomed to the surface of the packaging. This helps the GRAS material vaporize and otherwise separate from the plastic packaging and mix with the ingestible contents of the container. See Block 20.

Once fully packaged and processed, the ingestible product is shipped to retailers where it waits to be purchased by the consuming public. This period of wait can be from days to months long. As the packaged ingestible product sits over time, the adverse degassing of the plastic compound occurs. However, during this same period of time, the GRAS flavored material continues to bloom out of the plastic compound. See Block 22. The GRAS flavored material has an aroma that compliments the ingestible product and prevents the ingestible product from taking on the aroma or taste of the unwanted plastic emissions. Flavor scalping by the plastic is also mitigated by the presence of the GRAS flavors. Since the plastic polymers are supersaturated with GRAS flavors, there is no room for the plastic to scalp desirable flavors from the consumable materials.

As is shown by Block 24 and 26, as the GRAS scented material blooms out of the plastic packaging, it blooms to both the interior surfaces and the exterior surfaces of the packaging. Accordingly, the interior of the packaging continues to be flavored and/or aromatized over time, as does the exterior of the packaging.

The GRAS flavored material blooming from the interior of the packaging mixes with the ingestible material and the air surrounding the ingestible material. Accordingly, when the package is opened, the aroma can be smelled along with the natural fragrance of the ingestible material.

Furthermore, the exterior of the packaging also emits the scent of the GRAS flavored material. As is indicated by Block 28, the presence of the GRAS flavored material both inside and outside the packaging is used to produce a highly effective degree of olfactory sense deception, as is later described and illustrated.

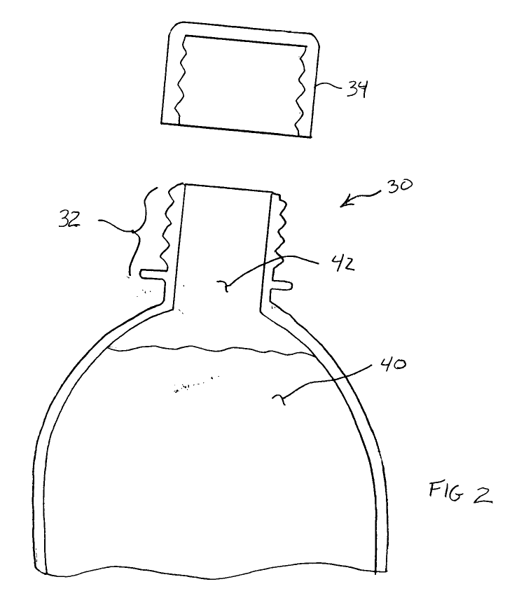

In FIG. 2, the present invention method of packaging is embodied in the packaging of a bottle of a beverage. Referring to FIG. 2, a bottle container 10 is shown. The bottle container 30 has threaded neck section 32 and a cap element 34 that is used to selectively open and close the bottle container 30. In the shown embodiment, the bottle container 30 is a water bottle that contains a volume of water, as an example of an ingestible product 40. However, it should be understood that the ingestible product 40 can be soda, beer, juice, yogurt or other type of beverage and the use of water is merely exemplary.

The bottle container 30 is molded from the mixture of plastic and GRAS flavored material that has previously been described. When filled at a bottling plant, the ingestible material 40 is filled to a predetermined level within the bottle container 30. The level to which the consumable liquid 40 is filled is typically below the neck section 32 of the container bottle 30. Consequently, a pocket 42 exists within the bottle container below the cap element and above the level of the ingestible material 40.

Since the bottle container 30 is molded from a plastic mixed with GRAS flavored material, it will be understood that the air immediately surrounding the exterior of the bottle container 30 contains the scent of the GRAS flavored material. This scent remains for as long as the GRAS flavored material blooms from the plastic, which can be several months or years, or until the container is opened. Furthermore, since the bottle container 30 is molded either entirely from the mixture of plastic or in the outer and inner layers of a container and GRAS flavored material, the scent of the plastic also is emitted into the interior of the bottle container 30. As such, it will be understood that the pocket 42 in the bottle container 30, between the cap element 34 and the consumable liquid 40, contains the aroma of the GRAS flavored material that was added to the plastic. Since the pocket 42 is confined until the cap element 34 is opened, the GRAS flavored material exiting the plastic becomes concentrated in the pocket 42. Accordingly, the aroma of the GRAS flavored material added to the plastic is particularly strong in the pocket 42, prior to the cap element 34 being opened.

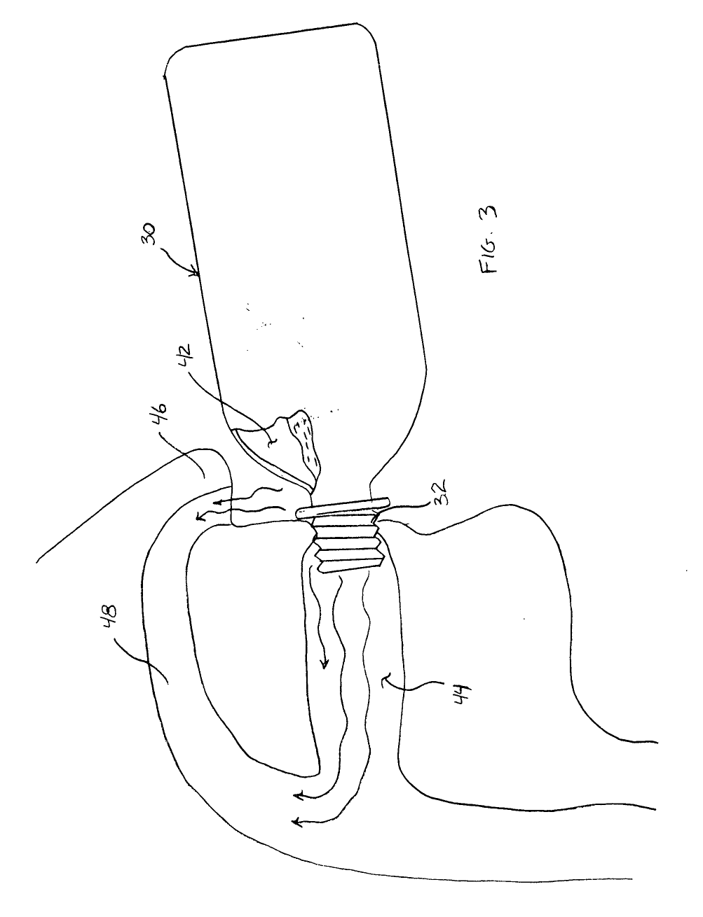

From FIG. 3, it can be seen that when a person wants to drink from the bottle container 30, the cap element 34 (FIG. 2) is removed. The top of the threaded neck section 32 is then brought into contact with the mouth. When the threaded neck section 32 of the bottle closure 30 is brought to the mouth, at least a small portion of the threaded neck section 32 passes into the mouth cavity 44. Furthermore, the pocket 42 within the bottle container 30 is exposed to the mouth cavity 44. This permits gasses within the pocket 42 to flow into the mouth cavity 44.

Additionally, as the threaded neck section 42 is brought into contact with the mouth 40, the exterior of the bottle container 30 is caused to pass under the nose 46. As the exterior of the bottle container 30 passes under the nose 46 and into the mouth cavity 44, a strong scent is provided to the air surrounding the nose 46. As such, should a person inhale through his/her nose 46 between swallows, the intake of air contains the desired aroma.

Simultaneously, since a portion of the threaded neck section 32 of the bottle container 30 is present inside the mouth cavity 44, the bottle container 30 is also emitting aroma within the mouth cavity 44. This emitted scent is reinforced by the passage of the gases from the pocket 42 of the bottle container 30 into the mouth cavity 44, wherein such gases contain a high concentration of the GRAS flavored material emitted by the plastic. The aromatized gases fill the mouth cavity 44, wherein the aroma enters the retro-nasal canal 48 from the rear of the mouth cavity 44. The scent filled vapors contained within the mouth cavity 44 also mixes with exiting air as a person exhales through his/her nose 46. Furthermore, small amounts of the scent filled gases are swallowed with the liquid being consumed. As a result, the scent is contained in any air that is belched and exhaled through the nose.

The saturation of the air within the mouth cavity 44 and the air surrounding the nose 46 with the aroma of the plastic greatly increases the ability of a person to perceive the aroma both immediately before and immediately after swallowing. As a result, the perception of the GRAS flavored material dominates the natural aroma of the ingestible material being consumed and a more complete olfactory sense deception occurs.

As olfactory sense deception occurs, the person drinking the fluid perceives a flavor in the fluid that is not actually contained in that fluid. If the fluid being drunk is pure water, the degree of olfactory sense deception is enhanced because the water does not have an aroma or flavor of its own to contradict the perceived flavor created by the flavored scented plastic. As a result, a person drinking a bottle of pure water will believe that the water being consumed is flavored even though no flavoring or other chemicals have been added to the water.

In the field of bottled water, it is a common practice to oxygenate water prior to bottling. One disadvantage of oxygenating water is that tends to more readily absorb a plastic flavor if stored in a plastic receptacle. By storing water in a bottle container made from a fragrance saturated plastic, the scent of the plastic will be absorbed by the water. This will provide the water with a favorable aftertaste rather than an undesired plastic aftertaste.

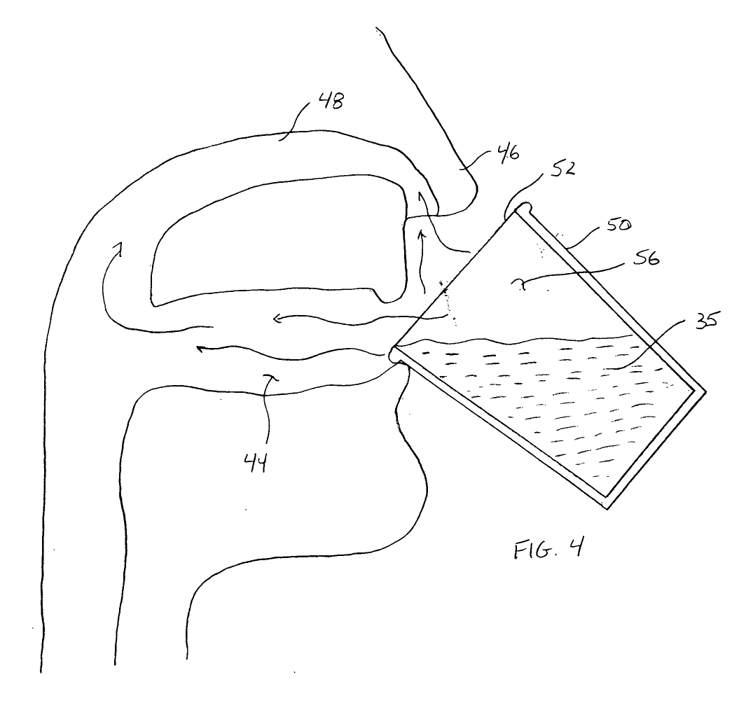

Referring to FIG. 4, a plastic cup-like container 50 is shown having an open top lip 52. The cup container may be a yogurt cup having a peel-away cover that has been removed. The cup 50 is fabricated from a plastic compound saturated with GRAS flavored material, as has previously been explained. When the cup 50 is filled with an ingestible product 35, the cup 50 is rarely filled to the brim of the lip 52. Rather, the cup 50 is filled to a level below its full capacity. This produces a reservoir area 56 above the liquid, but still within the cup 50, that contains air, vapors from the liquid and the scent emitted by the plastic of the cup 50.

As a person drinks from the cup 50, the lip 52 of the cup 50 passes within the mouth cavity 44 of the person drinking. Furthermore, the reservoir area 36 above the liquid 35 is also exposed to the mouth cavity 44 of the person drinking. As a result, flavor saturated plastic is positioned within the mouth cavity 44 when a person drinks and flavored/fragranced air from the reservoir area 56 is exposed to the mouth cavity 44 as the person drinks. The aroma of the GRAS flavored material therefore fills the mouth cavity 44, thereby leading to a more effective degree of aroma saturation within the retro nasal canal and sinuses. Since aroma from the plastic is both within the mouth cavity 44 and under the nose 46 of the person drinking from the cup 50, a more effective degree of olfactory sense deception for the reasons previously described.

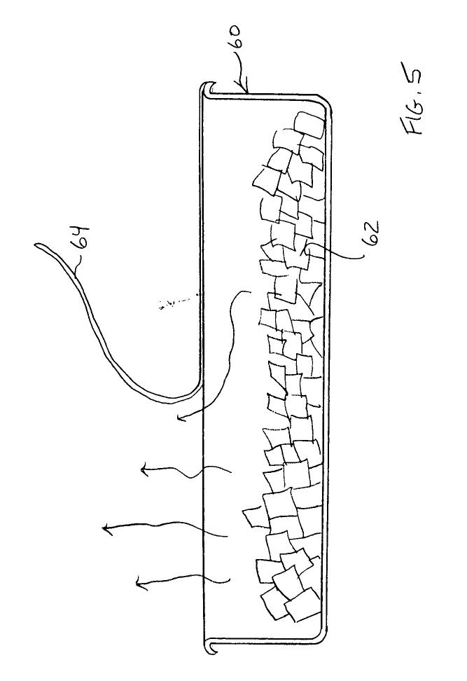

Referring to FIG. 5, a plastic tray container 60 is shown that supports a serving of solid food 62, such as a frozen dinner. The plastic tray container 60 may be covered with a removable film covering 64 that is removed once the food in the plastic tray container 60 is warmed and ready to be served.

The plastic tray container and/or the film covering 60 is made from a plastic supersaturated with GRAS flavored material, such as has previously been described. As such, for the period prior to when the food 62 is heated, the GRAS flavored material blooms onto the interior and exterior surfaces of the plastic tray container 60. When the food 62 and the plastic tray container 60 are frozen, little energy is available to cause the GRAS flavored material on the interior and exterior surfaces of the plastic tray container 60 to migrate into the air surrounding these surfaces. However, when the plastic tray container 60 is placed in a microwave oven or a convection oven, the energy provided to the plastic tray container 60 as the food 62 is heated causes the GRAS flavored material both inside and outside the plastic tray container 60 to migrate into and permeate the surrounding air.

The GRAS flavored material on the outside of the plastic tray container 60 permeates the air within the microwave oven or the convection oven as the food 62 in the plastic tray container 60 is heated. As such, when a person opens the door of the oven after heating, that person is greeted with a strong aroma of the GRAS flavored material. This initial aroma reinforces the natural scent of the food 62 being heated since this food 62 is typically confined below the thin film covering 64. This reinforced aroma serves two purposes. First, it masks any malodors that many occur from the degassing of the plastics. Second, the aroma has a psychological effect on the consumer. If what is perceived as the food has a strong good scent, the consumer anticipates that the food will be fresh and flavorful.

After the plastic tray container 60 is removed from an oven, the thin film, or paper covering 64 is removed. Once the thin film covering 64 is removed, the vapors trapped below the thin film covering 64 are released. These vapors include the natural aromatics of the food 62 as well as the concentrated GRAS flavored material that was heated and trapped below the thin film covering 64. As a result, when a consumer removes the thin film covering 64, that consumer is again provided with a strong aroma that causes the consumer to anticipate that the food will be fresh and flavorful and perhaps evoking warm memories of home made meals.

The aroma from the plastic tray container 60 continues to permeate the air as the food 62 is eaten. Accordingly, the olfactory sense of the person consuming the food 62 becomes saturated with the aroma of the GRAS flavored material in the plastic tray container 60. This causes olfactory sense deception in the person as that person eats the food 62. A person may therefore perceive flavors in the consumed food 62 that are not directly contained within the food 62.

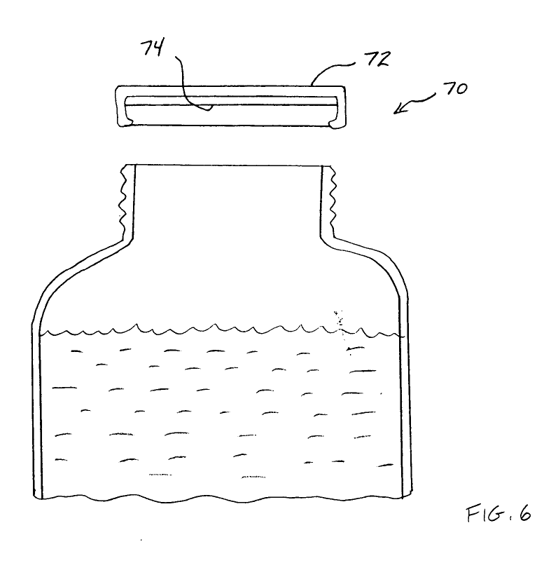

Referring now to FIG. 6, a glass bottle container 70 is shown having a metal snap-cap 72. Such bottle containers are popular for fruit juice, ice tea and other non-carbonated beverages. The only plastic present in such an assembly is a thin plastic seal 74 that is coated onto the inside of the metal cap 72. The plastic used to create the seal 74 is a plastic compound that is applied as a liquid and solidifies into an elastomeric solid. A common plastic used for creating such seals is sold in the bottling industry under the trade name Plastisol.

In accordance with the present invention, the plastic compound used to create the seal 74 on the metal cap 72 is supersaturated with GRAS fragrance material while the plastic compound is still in the liquid state. As the plastic compound cures, the fragrance material begins to bloom out of the plastic compound. The fragrance compound is exposed, in part, to the interior of the bottle container 70. As such, the air confined within the bottle container 70 becomes permeated with the fragrance material blooming from the cap seal 74.

The illustrated cap 72 and cap seal 74 are only one version of cap assembly that is used on non-plastic bottles and jars. In other forms, plastic gaskets are glued to the inside of plastic caps. Still other caps are manufactured partially from plastic and partially from metal. Regardless to the structure of the cap assembly, it will be understood that whatever plastic is exposed to the ingestible product being contained, that plastic can be supersaturated with fragrance material so that the fragrance material blooms out of the plastic over time and introduces the fragrance material to the ingestible product being contained.

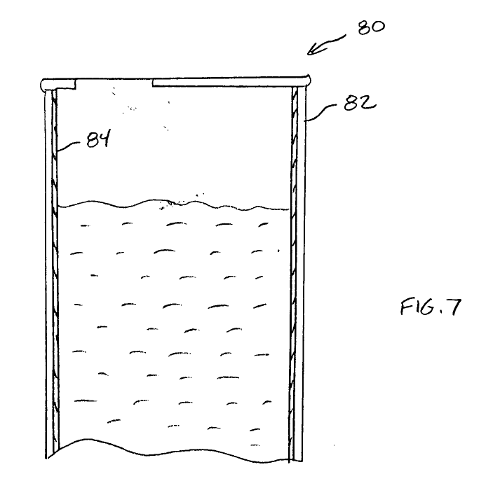

Referring now to FIG. 7, a can container 80 is shown. The can has an outer body form 82 made of metal or paperboard. The outer body form 82 is coated with an interior plastic lining 84. Such bottle containers are popular for food supplement beverages and beverages having added nutritional ingredients. The plastic compound used to create the interior plastic lining 84 is supersaturated with GRAS fragrance material while the plastic compound is still in the liquid state. As the plastic compound cures, the fragrance material begins to bloom out of the plastic compound. The fragrance compound is exposed, in part, to the interior of the can container 80. As such, the air confined within the can container 80 becomes permeated with the fragrance material blooming from the interior plastic lining 84.

The illustrated can container is only one version of a container that can have an interior plastic lining. In other forms, the can container can be a box container or bag container. Regardless to the structure of the container, it will be understood that whatever portion of the plastic lining that is exposed to the ingestible product being contained, that plastic can be supersaturated with fragrance material so that the fragrance material blooms out of the plastic lining over time and introduces the fragrance material to the ingestible product being contained.

It will be understood that the embodiments of the present invention described and illustrated herein are merely exemplary and a person skilled in the art can make many variations to the embodiments shown without departing from the scope of the present invention. All such variations, modifications and alternate embodiments are intended to be included within the scope of the present invention as defined by the appended claims.

What is claimed is:

1. A method of inducing olfactory sense deception in a consuming an ingestible product from a container, said method comprising the steps of:
providing a container having an internal surfaces and external surfaces, wherein said internal surfaces define an internal chamber, said container being formed at least in part from a plastic mixed with a fragrance material wherein said container emits an aroma of said fragrance material externally from said external surfaces and internally from internal surfaces into said internal chamber;
retaining an ingestible product within said internal chamber;
receiving said at least part of said container within the mouth, thereby bringing said external surfaces in close proximity to a consumer's nose, wherein aroma from said internal chamber flows into the mouth with the ingestible product being consumed and aroma from said external surfaces is perceived by the nose, therein creating olfactory sense deception in a perceived flavor of said ingestible product.

2. The method according to claim 1, wherein said plastic is mixed with said fragrance material so that said fragrance material supersaturates said plastic and blooms from said plastic over time.

3. The method according to claim 1, wherein the ingestible product in the container has a natural scent and said fragrance material has a scent that the same as said natural scent.

4. The method according to claim 2, wherein the ingestible product in the container has a natural scent and said fragrance material provides an aroma which is different from said natural flavor.

5. A method of adding olfactory detected properties to an ingestible product, comprising the steps of:
placing an ingestible product in a container that defines a confined space;
exposing said ingestible product in said container to plastic that is supersaturated with a fragrance material for a period of time sufficient to enable olfactory detected properties from said fragrance to permeate into said confined space of said container.

6. The method according to claim 5, wherein said step of exposing said ingestible product includes packing said ingestible product in packaging that contains said plastic.

7. The method according to claim 6, wherein said packaging contains plastic that provides adverse olfactory detected properties to said ingestible product.

8. The method according to claim 7, wherein said step of exposing said ingestible product to plastic includes exposing said ingestible product to plastic that contains a fragrance material that provides desirable olfactory detected properties to said ingestible product that counteracts said adverse olfactory detected properties.

9. The method according to claim 6, wherein said ingestible product has known olfactory detected properties that diminish over time, and said step of exposing said ingestible product in said container to plastic includes exposing said ingestible product to plastic that contains a fragrance material that provides said known olfactory detected properties to said ingestible product.

10. The method according to claim 5 wherein said ingestible product has known olfactory detected properties that diminish during processing, and said step of exposing said ingestible product in said container to plastic includes exposing said ingestible product to plastic that contains a fragrance material that replenishes said known olfactory detected properties.

11. The method according to claim 5, wherein said ingestible product has known olfactory detected properties, and said step of exposing said ingestible product in said container to plastic includes exposing said ingestible product to a plastic that contains a scented compound that provides complimentary olfactory detected properties to said known olfactory detected properties of said ingestible product.

12. The method according to claim 5, wherein said fragrance material is a food additive selected from GRAS additives that are generally recognized as safe by the Federal Food and Drug Administration.

13. A method of adding olfactory detected properties to an ingestible product, comprising the steps of:
providing a volume of ingestible material;
providing a mass of scented plastic having said olfactory detected properties;
confining said volume of ingestible material and said mass of scented plastic within a confined space for a period of time sufficient to cause said olfactory detected properties from said scented plastic to be at least partially absorbed by said volume of ingestible material.

14. The method according to claim 13, wherein said step of providing a mass of scented plastic includes providing packaging made from said scented plastic.

15. The method according to claim 14, wherein said step of confining said volume of ingestible material and said mass of scented plastic within a confined space includes sealing said ingestible material within said packaging.

16. The method according to claim 13, wherein said step of providing a mass of scented plastic includes molding packaging from a plastic supersaturatued with a fragrance material so that said fragrance material blooms from said packaging over time.

17. The method according to claim 16, wherein said fragrance material is selected from a group of FDA approved food additives.

18. A plastic bottle for holding a volume of a beverage, said bottle being molded from a plastic supersaturated with a fragrance material, wherein said fragrance material blooms from said plastic and scents space both within and immediately surrounding said bottle, wherein said fragrance causes olfactory sense deception to a person drinking the beverage directly from said bottle.

19. The bottle according to claim 18, wherein said fragrance material is a food additive having a GRAS designation by the Federal Food and Drug Administration.

20. A packaging container for a ingestible product, comprising:
a container defining an interior chamber and an opening for accessing said interior chamber;
a closure cap for engaging said container and selectively closing said opening, wherein said closure cap contains plastic that is exposed to said interior chamber of said container when said closure cap is on said opening, and wherein said plastic is supersaturated with fragrance material that blooms from said plastic over time.
